(19) United States
(12) Patent Application Publication
(10) Pub. No.: US 2011/0196574 A1
(43) Pub. Date: Aug. 11, 2011

(54) light energy saving function adapted to a traffic situation

(76) Inventor: Berengar Krieg, Gerlingen (DE)

(21) Appl. No.: 13/059,897

(22) PCT Filed: Jul. 1, 2009
(86) PCT No.: PCT/EP2009/058281

§ 371 Date: Apr. 28, 2011

(30) Foreign Application Priority Data
Aug. 19, 2008 (DE) 10 2008 041 355.0

(51) Int. Cl. B60Q 1/14

(52) U.S. Cl. 701/36

(57) ABSTRACT

A method, a device, a computer program and a computer program product are described for controlling a lighting system of a motor vehicle, in particular a headlight system of a motor vehicle involved in road traffic. The control process involves performing the operations of detecting a current traffic situation having at least detecting a motor vehicle speed and detecting a state of the lighting system and adjusting the state of the lighting system as a function of the detected traffic situation, the detection of the current traffic situation furthermore including the operation of detecting an obstacle, in order to adjust the lighting system as a function of the traffic situation thus determined.

### FIELD OF THE INVENTION

The present invention relates to a method for controlling a lighting system of a motor vehicle, in particular a headlight system of a motor vehicle involved in road traffic. The present invention further relates to a computer program including a program code arrangement for performing all of the steps of the method and to a computer program product including program code arrangement, which are stored of a computer-readable medium, in order to implement the method according to the present invention. The present invention also relates to a method for controlling a lighting system of a motor vehicle, in particular a headlight system of a motor vehicle involved in road traffic.

### BACKGROUND INFORMATION

Patent document WO 00/50260 discusses a control system for switching, automatically or partly automatically, from high beam to low beam and vice versa in a motor vehicle. For this purpose, a lighting state appropriate to the respective speed of the motor vehicle in accordance with specifiable prescriptions is ascertained via a control system and is set at least partly automatically.

### SUMMARY OF THE INVENTION

The exemplary embodiments and/or exemplary methods of the present invention relates to a method, a device, a computer program and a computer program product for controlling a lighting system of a motor vehicle, in particular a headlight system of a motor vehicle involved in road traffic according to the species defined in the independent claims.

The subject matter of the exemplary embodiments and/or exemplary methods of the present invention are all vehicles having lighting systems, position light systems and the like, which make use of methods, devices, computer programs and/or computer program products according to the species.

In particular, the method of the present invention, the device of the present invention, the computer program of the present invention, and the computer program product of the present invention for controlling a lighting system of a motor vehicle, in particular a headlight system of a motor vehicle involved in road traffic, having the features of the respective main claim or coordinated claim have the advantage of substantially reducing the energy required for lighting for a traffic situation in which no lighting or a reduced lighting is required, that is, when a vehicle is not actively involved in road traffic for example, as when stopping in front of a traffic light. For this purpose, the lighting system is switched on accordingly in an active involvement in road traffic or if this is required on account of the respective traffic situation, so as not to be exposed to additional safety risks.

Another advantage of the exemplary embodiments and/or exemplary methods of the present invention is that the lighting system is controllable in such a way that other road users, such as oncoming or preceding vehicles, bicyclists and/or persons, are not or are only negligibly affected by respectively controlling the lighting system, that they are not blinded for example.

By detecting the traffic situation, in particular with a view to a vehicle speed and/or a state of the lighting system of the vehicle that is traveling or involved in road traffic (where a shutdown of the vehicle does not count as being involved in road traffic), it is possible to implement a lighting state of a motor vehicle as a function of the traffic situation that is optimized with respect to energy consumption and safety. Adjusting a state of the lighting system may include a switchover from a state of the lighting system, for example a state of operational lighting or low beam, in which more energy is required and which is required for operating the vehicle or for being actively involved in road traffic, including high beam, to another state of the lighting system, for example an energy saving state or a parking lighting state, in which less energy is required, it being possible for the switchover to occur automatically, partly automatically or even manually. For a manual or at least partly automatic switchover, appropriate warning mechanisms may be provided, by which a user of the motor vehicle may be alerted to energy-saving measures brought about by the switchover. The switchover into the higher energy state—for example an operational lighting state—occurs, which may be automatically, so as to exclude a possible safety risk as a result of a mishandling on the part of the user.

Aside from a switchover, the adjustment may also include a continuous or discontinuous dimming, in which a number of different states of the lighting system are run through. So as not to endanger a user of the motor vehicle, in which the exemplary embodiments and/or exemplary methods of the present invention is implemented, the system additionally ascertains whether there is an obstacle to changing the state of the lighting system. If another motor vehicle is detected for example, a change of the state of the lighting system, for example switching to high beam or dimming, is for safety reasons admissible only within certain limits or not at all.

The detection of the obstacle may be performed at a distance for example, at which the obstacle is not or is no longer within the visual range of the driver of a motor vehicle. For this purpose, a detection goes beyond a mere recording, such as by a sensor for example. In one development, a detection includes a calculation of the recorded data, for example with the aid of complex algorithms. Thus it is also possible to detect variables derived from recorded variables such as the distance to an obstacle, for example a speed of approach toward the obstacle.

The measures specified in the dependent claims permit advantageous developments and improvements of the devices indicated in the independent and coordinated claims.

It is particularly advantageous that the detection of the obstacle further includes the step: Detecting an approach toward the obstacle in order to adjust the lighting system as a function of the traffic situation thus determined. The detection may be performed for example by measuring the distance to the obstacle or by measuring a speed at which the obstacle is approached, that is, derived variables of a distance measurement, for example changes of a distance over a period of time.

The detection may include a detection of additional parameters, in particular of parameters that are relevant for the respective traffic situation. These parameters may be selected for example from the group of parameters comprising the speed of the host vehicle, the size and speed of obstacles such as the speed of another vehicle, the brightness of the surroundings and the like. An adjustment may be performed in particular also as a function of these additional parameters. Thus, for example, an adjustment of the lighting system to a lower energy state, that is, dimming the lights, may occur only after the host vehicle's speed falls below a certain threshold, for example a speed of 10 km/h. It is also possible to perform an adjustment to a higher energy state of the lighting system, that is, brightening the lights, when a host vehicle's speed is exceeded, for example, beginning at 25 km/h. In particular, when a vehicle speed is near or equal to zero, a lower energy state may be set. Especially when parking, a high energy, full operational lighting of the motor vehicle is not required, particularly when no other road users are involved. Many motor vehicles have distance sensors and the like, which assist a driver when parking and/or by which a parking process may be performed without interventions of the driver. In such vehicles in particular, an illumination of the surroundings at a great lighting expenditure is normally not necessary. By recording the traffic situation, in particular by recording the presence of other relevant road users, a switchover to an operational lighting mode may be performed such that no safety risks arise for the user, or other road users.

The switchover or adjustment from a higher energy, brighter state to a lower energy, dimmed state or vice versa may occur discretely or continuously, that is, multiple discrete lighting states may be run through or a kind of dimming occurs, that is, a dimming or energy saving process is implemented continuously. Dimming may occur in accordance with a specifiable control curve, for example as a function of the vehicle speed, a distance to objects, the brightness of the surroundings and other parameters. The detection of relevant objects, that is, of obstacles, may include the detection of obstacles in a specifiable area surrounding the motor vehicle, in particular in a front area, in a lateral area and/or in a rear area. The area may be specified in a fixed manner or may be changed variably, for example with reference to the traffic situation. In this manner, the area may be increased, for example at higher driving speeds, and decreased at lower driving speeds. This ensures that objects relevant to the traffic situation, such as other motor vehicles, obstacles, persons, are recorded accordingly and are taken into account for the evaluation. This area may be set in accordance with the state of the lighting system, that is, for example an area that is illuminable given the state of the lighting system. Non-relevant objects or obstacles are accordingly not taken into account in an adjustment of the state, whereby a data reduction is ensured, which makes for a faster response time. Depending on the traffic situation, only certain areas may be taken into account, for example only a front area when parking in the forward direction.

The recorded parameters may be evaluated individually or in combination, that is, cross-linked with one another, in order to ensure a lighting state that is optimized with respect to energy as well as safety.

Another advantage of the exemplary embodiments and/or exemplary methods of the present invention is that the detection of the current traffic situation furthermore includes the step of detecting at least one ambient condition such as the brightness of the surroundings or road conditions. This makes it possible to limit an activation of the light of a lighting system to a minimum in daylight for example. Moreover, on a roadway wet from rain for example, the lighting system may be adjusted in such a way that reflections blind other traffic participants as little as possible. The detected parameters in particular may be cross-linked with one another.

The adjustment may include a reduction or increase of an energy supply of the lighting system if the state of the lighting system, for example an illuminated area, the motor vehicle speed, speed of approach toward an obstacle, a time variable and/or variables accordingly derived therefrom, reach or pass a respectively corresponding limit value. These conditions may each for itself effect a change in the adjustment. It is more advantageous however, if multiple parameters are connected by a logical AND in order to ensure a high safety standard. The more parameters are connected with one another, the higher will be the safety for all road users.

Another advantage of the exemplary embodiments and/or exemplary methods of the present invention is that the reduction or increase includes switching to or switching back from an energy saving state comprising a stand-by state or an off-state of the lighting system. A switchover to the energy saving lighting state may thus include switching the lights off. This makes it possible to save a maximum of energy for lighting.

One advantage is that the switchover from the energy saving lighting state to the operational lighting state is performed in a time-dependent, speed-dependent and/or object-dependent manner, all three parameters may be taken into account when switching over in AND conjunction. The switchover from the operational lighting state to the energy saving lighting state occurs as a function of the traffic situation. Accordingly, a switchover from the energy saving lighting state to the operational lighting state is made to depend on corresponding parameters. Thus, when the driving speed increases for example, for example when starting from a parked or stopped state, the operational lighting state is automatically switched on since it must be assumed accordingly that there is an active involvement in road traffic. This may be coupled for example with data of a motion sensor, which records for example inclinations, accelerations, cornering and the like.

The device according to the present invention for controlling a lighting system of a motor vehicle, in particular a headlight system of a motor vehicle involved in road traffic, having the features of the respective claim, has the advantage over the related art that the use or the implementation of the method according to the present invention makes it possible to set a lighting state that is optimized with respect to energy and safety. Already existing lighting systems may be retrofitted with an appropriate arrangement such that already existing lighting systems may also be optimized in terms of energy and safety. The device according to the present invention for controlling a lighting system of a motor vehicle may have at least one detection device for detecting a current traffic situation including at least one detection unit for detecting a motor vehicle speed and a detection unit for detecting a state of the lighting system and a control device for controlling the state of the lighting system as a function of the detected traffic situation.

In addition, the detection device further includes at least one detection unit for detecting an obstacle in order to adjust the lighting system as a function of the traffic situation thus determined. The detection units may be sensors of simple or complex construction or even computing and control devices, for determining for example derived variables from recorded variables, such as for example a change of distance or a speed of approach derived from a distance to an obstacle. It is advantageous for example that a control device is provided, which includes at least one sensor for detecting at least one parameter of a traffic situation, which may have multiple sensors. The sensors may be developed to record a parameter such as the speed of the host vehicle, other vehicle speed(s), objects relevant to the traffic situation such as other motor vehicles, brightness values of the surroundings, road conditions and the like, in order to make it possible to set a suitable state of the lighting system, in which an appropriate illumination is ensured for being actively involved in road traffic. The parameters, for example, may be used individually or in combination, for example in an AND conjunction, for setting an energy saving lighting state, in which the lighting is reduced in such a way that there can be no active involvement in road traffic, a new switchover occurring into the operational lighting state if the current traffic situation as a function of the detected parameters requires it. A simple lighting adjustment may be implemented using the appropriate components. The components according to the present invention are readily integrated into existing lighting systems via suitable interfaces.

Another advantage of the exemplary embodiments and/or exemplary methods of the present invention provides for the detection unit for detecting an obstacle to be developed as at least one distance sensor unit including at least one ultrasonic sensor, in particular at least one ultrasonic sensor of a parking assistance. These distance sensors are readily retrofitted and in part already exist in motor vehicles such that they may be readily used for a functional extension with regard to adjusting the lighting system.

It is in particular advantageous that the control device is coupled with a headlight control for implementing at least one lighting state, in order to implement an appropriate lighting state as a function of the traffic situation. Thus it is possible for example to couple and extend brightness-controlled lighting systems, which switch a lighting system on or off depending on the ambient brightness, with the functions according to the present invention.

Advantageously, the method may be implemented as a computer program and/or computer program product. This includes all computing units, in particular also integrated circuits such as FPGA's (field programmable gate arrays), ASIC's (application specific integrated circuits), ASSP's (application specific standard products), DSP's (digital signal processors) and the like as well as hardwired computing modules. By simple programming and by inserting or transferring relevant components or relevant program code, a simple installation or retrofitting is possible.

An exemplary embodiment of the present invention is illustrated in the drawing and explained in greater detail in the following description.

### BRIEF DESCRIPTION OF THE DRAWINGS

FIG. 1 shows a schematic flow chart of an exemplary embodiment of the method according to the present invention.

FIG. 2 shows a schematic representation of a motor vehicle having a device according to the present invention.

### DETAILED DESCRIPTION

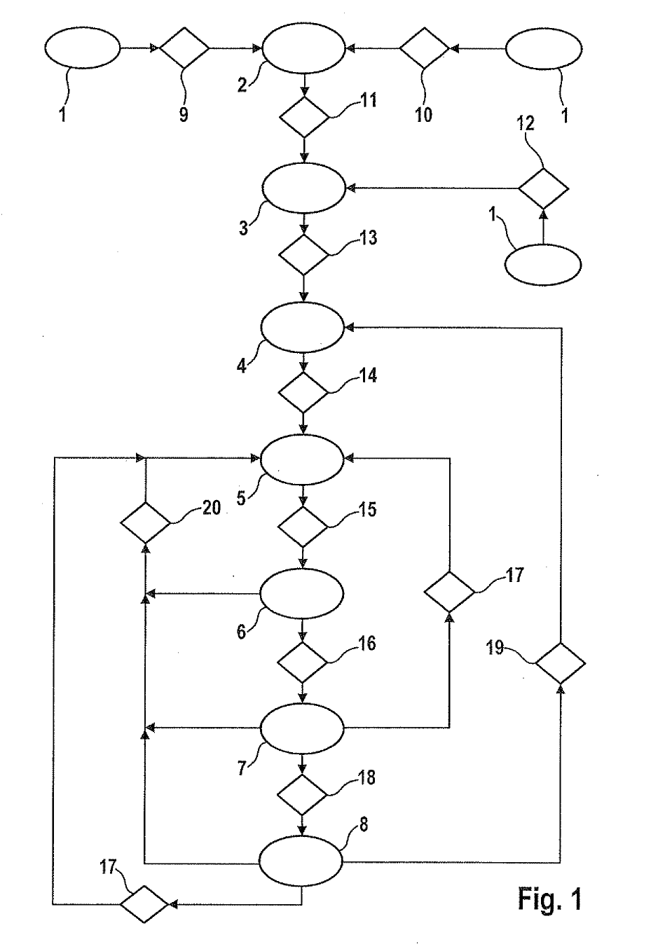

FIG. 1 shows schematically a flowchart of an exemplary embodiment of the method according to the present invention. The ovals shown in the figure indicate various states 1 through 8, while the lozenges indicate various transition conditions 9 through 20, which will be explained in more detail in the following in relation to the corresponding reference numeral. The states and/or steps differ based on a driving situation of the motor vehicle and/or based on the tasks of a sensor system and/or a control system. The illustrated states/steps indicate possible scenarios that arise when the system is in use.

State 1 indicates an arbitrary state while a motor vehicle is traveling. Starting from arbitrary state 1, which is shown three times in the figure and which may correspond to any of the other states 2 through 8, it is possible to reach a respective subsequent state. In state 1, for example, the low beam and/or the high beam may be switched on or switched off. State 1 thus indicates an arbitrary driving scenario. Starting from arbitrary state 1, for example in the upper left corner of the figure, a state 2 is reached via transition condition 9, that is, switching off the lights of the vehicle.

In state 2, the switch-off of the low beam of a motor vehicle is deactivated. State 2 is assumed as the first state (initial state) when the vehicle or the lighting system is put into operation.

Starting from any arbitrary state 1, for example on the top right in the figure, or any arbitrary state 3 through 8, the transition condition 10 detects an error in the lighting system, more precisely in the control or regulating system of the lighting system, or an error is detected in a system or sensor necessary for recording the current traffic situation and involved in connection with this function.

Both transition conditions 9 and 10 admit as a further state only state 2, in which the method for switching to an energy saving lighting state cannot be implemented, that is, in which a low beam switch-off is not active. Thus the lighting system cannot be switched (automatically) in accordance with the method.

Starting from state 2, that is, from a deactivated low beam switch-off, with the fulfillment of transition condition 11—the low beam being on or being switched on—a transition is made to state 3, the low beam is switched on and transition condition 10 is not fulfilled. The low beam switch-off is not yet active at this point, as indicated by state 3; that is, the low beam is switched on, the low beam switch-off is not activated however. Thus, in state 3, the headlights of the lighting system are supplied with current. The current may be supplied at a varying magnitude, that is, at a varying voltage and/or amperage. The magnitude of the current supplied is fundamentally proportional to the brightness of the lighting system, that is, the greater the magnitude of the supplied current, the brighter are the lights. The deactivation of the low beam is not active, although not defective. In this state 3 (and also in states 4 through 8), a check is performed as to whether the present mode of functioning is to be activated on a sustained basis. This may be done for example via a separate switch device on a respective light switch. Alternatively, this may also be implemented for example via an onboard computer menu, for example as a signal via a vehicle data bus, such as a CAN bus, a Flexray bus, a LIN bus, or via other signal transmission paths. If this check is successful, i.e. if it is determined that the function should be active on a permanent basis, then transition condition 13 is fulfilled. If the check is not successful, then transition condition 12 is fulfilled, and the system remains in state 3 or changes from states 4 through 8 into state 3. If an error is detected in the cross-linkage or the recording of the required signals, transition condition 10 is fulfilled and the system switches over to state 2.

State 3 may thus also be reached starting from an arbitrary state 1, indicated on the right side approximately at the center of the Figure, when the low beam switch-off is deactivated, as shown by transition condition 12.

Thus, with the low beam switched on and low beam switch-off inactive, state 3 may be reached from an arbitrary state 1 as follows:
a) No low beam is switched on and the low beam is accordingly switched on subsequently.
b) The low beam switch-off is deactivated (the low beam may already be switched on in the incoming circuit or may be switched on subsequently).

Starting from state 3, state 4 may be reached in a subsequent step. State 4 is characterized by the fact that the low beam switch-off is activated, which may occur for example via an additional switching unit or via an onboard computer.

In state 4, the low beam is activated and the headlights are controlled or supplied with current accordingly. The control may comprise the supply of current. In particular, the control is implemented via a reduction or increase of a current supply. The brightness generated varies with the magnitude of the current supply. The higher the current supply, the brighter will be the lighting system and vice versa. Furthermore, the deactivation of the low beam is not active. In this state 4, a check is performed to determine whether a detected vehicle speed exceeds an applicable vehicle speed threshold (e.g. 15 km/h), transition condition 14. If this is the case, the system switches to state 5. If on the contrary the low beam is deliberately switched off, that is, not automatically on the basis of the method according to the present invention, for example by a user intervention, or an error is detected in the cross-linkage and the recording of the required signals, then the system switches to state 2.

State 5 is characterized by the fact that the low beam is activated and the headlights are controlled or supplied with current. The deactivation of the low beam is not active. In this state 5, a check is performed using transition condition 15 to determine whether the vehicle speed falls below or reaches an applicable speed threshold, for example a second speed threshold (e.g. 0 km/h). If this is the case, the system switches to the next state 6.

If the low beam is switched off from outside this function or if an error is detected in the cross-linkage and the recording of the required signals, then the system switches to state 2.

In state 6, the actual driving speed of the motor vehicle now falls below or reaches the preset second vehicle speed threshold. State 6 is marked by the following characteristics: The low beam is activated; the headlights are controlled/supplied with current. The deactivation of the low beam is not active. In state 6, a check is performed via provided sensors, for example short-range sensors, as to whether an obstacle exists in front of the vehicle or whether other relevant objects are present. Depending on the characteristics/equipment of the sensors, a check may be performed regarding a minimum distance to a relevant object, in particular an obstacle, a stage of the approach warning, or a number and position of the sensors (e.g. only the middle two of four sensors for example). The minimum distance may be set as a function of a vehicle speed. In a speed range from 0 to 5 km/h, the minimum distance may be about 50 cm for example. If this check/transition condition 16 is successful according to specified setpoint values, then the system switches to state 7. If in state 6 the vehicle speed exceeds the applicable speed threshold, for example a third speed threshold (e.g. 3 km/h), transition condition 20, then the system switches to state 5. If the low beam is switched off from outside this function or if an error is detected in the cross-linkage and the recording of the required signals, then the system switches to state 2.

State 7 is characterized as follows: The low beam is activated, the headlights are controlled/supplied with current. The deactivation of the low beam is not active. When entering this state 7, a specifiable time T (e.g. 2 seconds) is started. In state 7, using transition condition 17, which for reasons of clarity is indicated here several times, a check is performed to determine whether furthermore a relevant obstacle is detected in front of the vehicle via the short-range sensors. Transition condition 20 is also additionally verified, more precisely, whether the vehicle speed does not exceed the applicable respective, in particular third speed threshold (e.g. 3 km/h). If time T has elapsed, if transition condition 18 is fulfilled, which is verified in state 7, and the two checks 17 and 20 are not successful, that is, correspond to certain specifications, then the system switches to state 8. Otherwise, the system switches to state 5. If the low beam is switched off from outside this function or if an error is detected in the cross-linkage and the recording of the required signals, then the system switches to state 2.

State 8 is characterized as follows: The deactivation of the low beam is active, the headlights are not controlled/supplied with current or they are switched from an operational lighting state to an energy saving lighting state. This may occur discretely or continuously, that is, multiple discrete lighting states may be run through or a kind of dimming process occurs, that is, a dimming or energy saving process is implemented continuously. In this state 8, transition conditions 17 and 20 are checked. If these checks are not successful, then the system switches to state 5. Additionally, a check is performed as to whether the function is temporarily deactivated. A signal for the temporary deactivation of the function may be implemented e.g. from the activation of the headlight flasher in this state while a high beam switch-on is suppressed. The signal for the temporary deactivation may also be formed externally, however, and be made available to the function for example as a signal via a CAN, Flexray, LIN, an HW line or other signal transmission paths. If the function is temporarily deactivated, which is checked by transition condition 19, the system switches to state 4. If the low beam is switched off from outside this function or if an error is detected in the cross-linkage and the recording of the required signals, then the system switches to state 2.

In contrast to conventional passenger cars, the low beam, if it was activated, does not remain switched on during at a traffic light stop behind a preceding vehicle or during a standstill period in a traffic jam. This is not necessary for traffic safety. Short-range sensors may also be used for the present invention, which are already installed in many vehicles in the front or also in the rear (e.g. parking sensors). These sensors may be cross-linked with driving speed information, which is detectable by appropriate sensors, for example wheel speed sensors, and with the headlight control, in order to switch off the low beam for the standstill period so as to save electrical energy and thus fuel in vehicles having an internal combustion engine.

In vehicles having an electronic lighting switch-on system (e.g. an automatic switch-on via a brightness sensor), the function may be implemented without additional hardware costs. In vehicles having standard H4 or H7 lighting arrangement in the main headlights, approximately 2 *55 W, that is, 110 W of electrical power may be saved for the standstill period. These 110 W must be generated from the fuel via the alternator or generator at an efficiency of approximately 95% and the internal combustion engine, whose efficiency while idling is certainly below 30%. Per hour of standstill time, it is possible to save 1 h*110 W/(0.95 *0.3)=0.386 kWh, which corresponds to the energy content of 0.043 liters of gasoline or 0.039 liters of Diesel fuel. With the low beam switched on, an additional consumption of 0.2 liters fuel per 100 km is measurable in a passenger car. At an assumed average speed of 50 km/h, the theoretical value of the fuel savings could be exceeded and up to 0.1 liter fuel per hour could be achieved. These values may also be achieved for vehicles having a start-stop function, since the electrical energy must be provided in the further driving cycle, while during the standstill period, however, the load is removed from the vehicle electrical system and thus the possible standstill period is extended.

In connection with a software functionality, the short-range sensors at the front of the vehicle are to be cross-linked with the driving speed information and the headlight control in such a way that the low beam is switched off after an applicable time of a few seconds for example (e.g. 2 sec.) after undershooting an applicable vehicle speed and the detection of another vehicle or an obstacle in front of the vehicle. If the vehicle is standing and/or stopping without another vehicle in front of it (as the first vehicle at the traffic light), then the low beam is not switched off in order to continue to make the vehicle recognizable to oncoming traffic.

Via an additional switch position or via a suitable onboard computer menu, this function may be switched on or switched off permanently if the driver of the vehicle does not wish to use this function. It is also possible to provide for a quick, temporally limited deactivation of the function (e.g. by actuating the headlight flasher while suppressing the high beam), e.g. for maneuvering when entering or leaving a parking space. This deactivation may be reversed by exceeding an applicable vehicle speed. When starting a trip or when starting the engine, the function should only become active after a speed threshold has been exceeded so as not to become active already e.g. when starting to drive in a parking space.

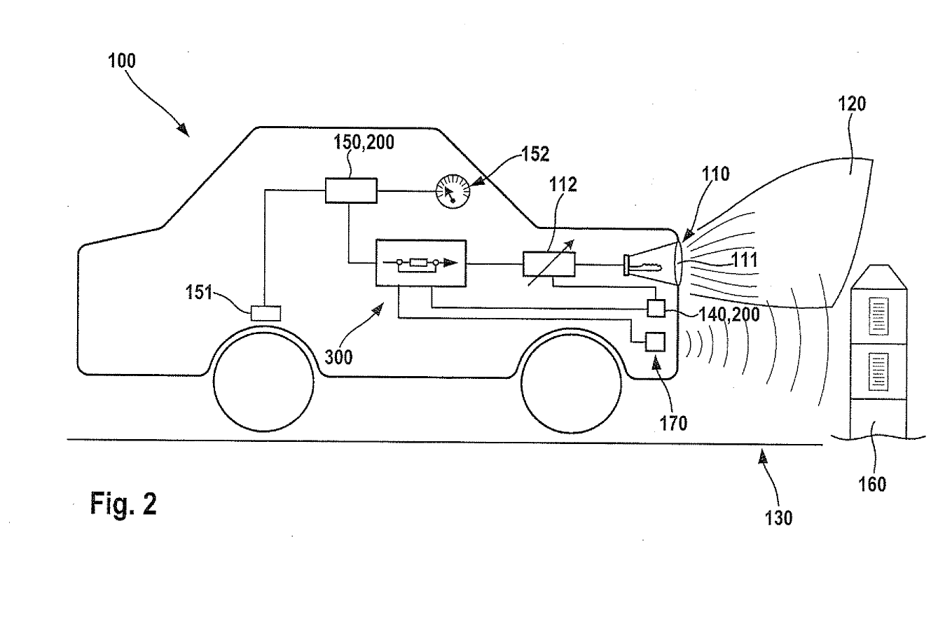

FIG. 2 shows schematically a motor vehicle 100 having a device according to the present invention for controlling a lighting system 110 of the motor vehicle 100. Lighting system 110 comprises multiple headlights 111, only one of which is shown here. As a function of a control, headlight 111 emits a corresponding light cone 120 for illuminating a surroundings of the motor vehicle 100, in particular a road 130. A headlight control 112 is provided for controlling headlights 111. Via headlight control 112, headlights 111 may be adjusted in such a way that they emit varying light and thus varying brightness. The adjustment of the brightness may be controlled for example via the supply of current to headlights 111.

In order to adjust a respective brightness of headlights 111 in optimized fashion, a detection unit 140 is provided for detecting a state of lighting system 110. Detection unit 140 may be developed as a light sensor for example. In another specific embodiment, detection unit 140 may be coupled with headlight control 112 such that via various control variables a state of lighting system 110 may be inferred, for example via a current supply.

In order to adapt lighting system 110 to the respective traffic situation in optimized fashion, a detection unit for detecting a motor vehicle speed 150 is additionally provided. This detection unit 150 may comprise wheel speed sensors 151 for example, as shown in FIG. 2.

Additionally, detection unit 150 may be coupled with a speed indicator 152 or with the corresponding data lines, as also shown in FIG. 2, in order thus to detect the motor vehicle speed. Detection units 140 and 150 together form a detection device 200 for detecting a current traffic situation, detection device 200 possibly comprising additional detection units for detecting various parameters, which are relevant for detecting a current traffic situation, such as brightness sensors or the like, which are not shown here however.

Another detection unit, which is comprised by detection device 200, is a detection unit 170 for detecting an obstacle 160. Detection unit 170 is developed in FIG. 2 as a distance sensor unit, in particular as a sonic sensor, more precisely as an ultrasonic sensor, and may be a component of a parking assistance device. With the aid of detection unit 170, it is thus possible to detect obstacles 160, which are relevant for the traffic situation, i.e. with respect to which there exists the potential risk of a collision.

In order to control lighting system 110 as a function of a traffic situation detected with the aid of detection device 200, both lighting system 110 as well as detection device 200 are coupled with a control device 300. Via the detected data, control device 300 is able to control headlight control 112 accordingly such that lighting system 110 is adjustable or controllable in accordance with the detected data.

1-10. (canceled)

11. A method for controlling a lighting system of a motor vehicle while the motor vehicle is in operation, the method comprising:
determining a current traffic situation by at least a detecting a motor vehicle speed and detecting a state of the lighting system; and
adjusting the state of the lighting system as a function of the detected traffic situation;
wherein the detection of the current traffic situation includes detecting an obstacle to adjust the lighting system as a function of the determined traffic situation.

12. The method of claim 11, wherein the detecting of the obstacle includes detecting an approach toward the obstacle to adjust the lighting system as a function of the determined traffic situation.

13. The method of claim 11, wherein the determining of the current traffic situation includes detecting at least one ambient condition, which includes at least one of a brightness of a surrounding and a road condition.

14. The method of claim 11, wherein the adjustment is implemented as a reduction or increase of an energy supply of the lighting system of at least one of the state of the lighting system, the motor vehicle speed, the speed of approach toward an obstacle, a time variable, and variables derived therefrom.

15. The method of claim 11, wherein the reduction or increase comprises a switching into or a switching back from an energy saving state comprising a stand-by state or an off-state of the lighting system (110).

16. A computer readable medium having a computer program, which is executable by a processor, comprising:
a program code arrangement having program code for controlling a lighting system of a motor vehicle while the motor vehicle is in operation, by performing the following:
determining a current traffic situation by at least a detecting a motor vehicle speed and detecting a state of the lighting system; and
adjusting the state of the lighting system as a function of the detected traffic situation;
wherein the detection of the current traffic situation includes detecting an obstacle to adjust the lighting system as a function of the determined traffic situation.

17. The computer readable medium of claim 16, wherein the detecting of the obstacle includes detecting an approach toward the obstacle to adjust the lighting system as a function of the determined traffic situation.

18. A device for controlling a lighting system of a motor vehicle, comprising:
at least one detection device for detecting a current traffic situation having at least one speed detection unit for detecting a motor vehicle speed and a state detection unit for detecting a state of the lighting system; and
a control device for controlling the state of the lighting system as a function of the detected traffic situation;
wherein at least one detection device includes at least one detection unit for detecting an obstacle to adjust the lighting system as a function of the determined traffic situation.

19. The device of claim 18, wherein the detection unit for detecting an obstacle is configured as at least one distance sensor unit having at least one ultrasonic sensor, which is for parking assistance.

20. The device of claim 18, wherein the control device is coupled with a headlight control for implementing at least one lighting state, so as to implement an appropriate lighting state as a function of the traffic situation.
